(19) United States
(12) Patent Application Publication
(10) Pub. No.: US 2007/0001964 A1
(43) Pub. Date: Jan. 4, 2007

(54) Display device and method of driving the same

(75) Inventors: Ju Young Lee, Gyeongsangbuk-do (KR); Jae Bum Chun, Gyeonggi-do (KR)

Correspondence Address: JENKENS & GILCHRIST, P.C., 901 15TH STREET N.W., SUITE 900, WASHINGTON, DC, 20005, US

(73) Assignee: LG.PHILIPS LCD CO., LTD., Seoul (KR)

(21) Appl. No.: 11/370,986

(22) Filed: Mar. 9, 2006

(30) Foreign Application Priority Data
Jun. 30, 2005 (KR) 10-2005-0057546

(51) Int. Cl. G09G 3/36

(52) U.S. Cl. 345/96

(57) ABSTRACT

A driving circuit of a liquid crystal display device capable of processing interlace type video signals, includes a data driver inverting a polarity of a pixel data at least every two-field period, converting the pixel data every field period according to a variable gamma voltage, and supplying the inverted pixel data to a liquid crystal display panel, a value of the gamma voltage changing every field period.

The present invention claims the benefit of Korean Patent Application No. 057546/2005 filed in Korea on Jun. 30, 2005, which is hereby incorporated by references.

### BACKGROUND OF THE INVENTION

1. Field of the Invention

The present invention relates to a display device, and more particularly, to a liquid crystal display device and a method of driving the same that provide improved image quality.

2. Discussion of the Related Art

Cathode ray tubes (CRTs) are heavy and bulky. To solve these disadvantages of the CRTs, flat panel display devices have been developed. Examples of the flat panel display devices include a liquid crystal display device (LCD), a field emission display (FED), a plasma display panel (PDP), and an electro-luminescence (EL) display device. The flat panel display device displays an image on a panel using an external image signal, e.g. a computer display signal or a television broadcast signal. The flat panel display device for displaying the image signal includes a panel displaying the image signal and a driver driving the panel to display the image signal.

There are two types of display driving methods, a progressive type and an interlace type. The progressive type driving method provides an image signal of one screen, i.e., by one frame period, while the interlace type divides one screen into odd-fields displaying odd horizontal lines and even-fields displaying even horizontal lines. A representative interlace type driving method is television (TV) broadcast, and a television set is a representative interlace type display device. TV broadcast transmits display signals in the order of the odd-fields and the even-fields, and a television set processes broadcast TV signals as-is.

A representative progressive type driving method is a computer display signal, and a PDP device and an LCD device are representative progressive type display devices. A computer transmits display signals by a frame period, and a PDP device and an LCD device process inputted display signals by a frame period. Accordingly, it is difficult for a PDP device or an LCD device to display TV signals as-is.

In general, an LCD device includes a liquid crystal panel having a plurality of pixels arranged in a matrix to display an image and a drive unit driving the liquid crystal panel. The liquid crystal panel has a plurality of horizontal lines, a plurality of vertical lines, and a plurality of the pixels defined by crossing of the horizontal lines and the vertical lines. Additionally, pixel electrodes are formed on the pixels, and also red, green, and blue color filters are formed on the regions corresponding to the pixels.

The drive unit includes a gate driver sequentially supplying scan signals to the horizontal lines, a data driver supplying a predetermined image signal to the vertical lines, and a timing controller generating control signals for controlling the gate driver and the data driver. The horizontal lines are sequentially driven by the scan signals supplied from the gate driver, and the image signals supplied from the data driver are applied to the pixels using the vertical lines to display a predetermined image through the color filters. Thus, the image signals of one frame are displayed in response to the sequentially driven horizontal lines.

Therefore, the progressive type is appropriate for the liquid crystal display device having the sequentially operating horizontal lines. In particular, since the horizontal lines are operated in the liquid crystal display device regardless of odd horizontal lines and even horizontal lines, the progressive type is appropriate.

On the other hand, when an interlace image signal supplied from a broadcasting station is supplied to a liquid crystal display device, it is difficult to display the interlace image signal on the progressive type liquid crystal display device. To solve this problem, the interlace image signal supplied to the liquid crystal display device is inverted into the progressive image signal, and then the inverted progressive image signal is displayed on the liquid crystal display device. However, additional devices, e.g., a data converter and a frame memory, are required to convert the interlace image signal into the progressive image signal before applying to a liquid crystal display device, such that a circuit of the liquid crystal display device becomes complicated and manufacturing cost is increased.

A method of directly displaying an interlace image signal on a liquid crystal display device without converting an interlace image signal into a progressive image signal has been provided. In particular, the liquid crystal display device generates dummy pixel data on the even horizontal lines using actual pixel data existing on adjacent odd horizontal lines when odd-fields are supplied. Also, the liquid crystal display device generates dummy pixel data on the odd horizontal lines using actual pixel data existing on adjacent even horizontal lines when even-fields are supplied.

FIG. 1A is a view illustrating polarity arrangement of odd-field pixel data according to the related art, and FIG. 1B is a view illustrating polarity arrangement of even-field pixel data according to the related art. As shown in FIG. 1A, for odd-fields, actual pixel data, shown as shaded, is displayed on odd horizontal lines, and dummy pixel data is displayed on the even horizontal lines. As shown in FIG. 1B, for even-fields, dummy pixel data is displayed on the odd horizontal lines and actual pixel data, shown as shaded, is displayed on the even horizontal lines.

Thus, the liquid crystal display device displays the pixel data of the odd-field by sequentially driving each horizontal line, and also displays the pixel data of the even-field by sequentially driving each horizontal line during the next frame. Therefore, the liquid crystal display device directly displays the interlace image signals with the odd-fields and the even-fields. At this point, the dummy pixel data is at least smaller than the actual pixel data. Since the actual pixel data exists on the odd horizontal lines of the odd-fields and the dummy pixel data also exists on the even horizontal lines of the odd-fields, the odd-fields can constitute one complete frame. Also, the dummy pixel data exists on the odd horizontal lines of the even-fields and the actual pixel data exists on the even horizontal lines of the even-fields, the even-fields can constitute one complete frame.

FIG. 2 is a view illustrating pixel data displayed over time according to the related art, and FIG. 3 is a graph illustrating an amount of a data change over time in one pixel on odd horizontal lines illustrated in FIG. 2. As shown in FIG. 2, the interlace image signal is dot-inverted by a field period in order to improve a display quality. In particular, the odd-fields and the even-fields of the interlace image signal are sequentially displayed for the odd-field period and the even-field period.

As shown in FIG. 3, positive actual pixel data with respect to a common voltage Vcom is charged in a predetermined pixel on the odd horizontal lines during the odd-field (OF) period and negative dummy pixel data is charged in the pixel during the even-field (EF) period. Using this method, the actual pixel data and the dummy pixel data are charged in turn every field period.

Since the dummy pixel data is calculated using the actual pixels of the adjacent horizontal lines, the actual pixel data has the absolute value much larger than that of the dummy pixel data. Accordingly, the voltage charged in the pixel on the odd horizontal lines and the even horizontal lines has an average voltage (DC voltage) having positive polarity with respect to the common voltage Vcom when the OF period and the EF period are repeated. Therefore, the DC voltage having the positive polarity remains in the pixel, thereby generating severe afterimages.

FIG. 4 is a view illustrating pixel data displayed over time according to the related art, FIG. 5 is a graph illustrating an amount of a data change over time in one pixel on the odd horizontal lines illustrated in FIG. 4, and FIG. 6 is a graph illustrating a flicker generation in a liquid crystal display device of FIG. 4 according to the related art.

As shown in FIG. 4, the polarity of the pixel data is inverted by two-field period, i.e., an odd-field and an even-field, to address the problem shown in FIG. 3. As shown in FIG. 5, positive actual pixel data with respect to the common voltage Vcom is charged in a predetermined pixel on the odd horizontal lines during the first OF period, and positive dummy pixel data is charged in the pixel during the first EF period. Additionally, negative actual pixel data is charged in the pixel during the second OF period, and negative dummy pixel data is charged in the pixel during the second EF period. Through these processes, the polarity of the pixel data is inverted each a two-field period.

Since the positive actual pixel data charged during the first OF period and the positive dummy pixel data charged during the first EF period, and the negative actual pixel data charged during the second OF period and the negative dummy pixel data charged during the second EF period cancel each other. Additionally, the average value (DC voltage) of the data becomes almost zero. Therefore, the DC voltage is not applied to the pixel, and then an afterimage is not generated.

However, even when the afterimage is prevented by inverting the polarity of the pixel data by the two-field period, flickers are generated. As shown in FIG. 6, positive actual pixel data is charged in a predetermined pixel on the horizontal lines during an OF period. Subsequently, positive dummy pixel data is charged in the pixel during the EF period. Since the same positive polarity is supplied during both the OF period and the EF period, the actual pixel data charged during the OF period are not discharged completely and a portion of a DC voltage remains. Therefore, the remaining DC voltage during the OF period is added to the dummy pixel data during the EF period, and then dummy pixel data larger than the dummy pixel data is charged during the EF period. Such a process repeats every EF period. Therefore, since an actual image is not displayed during the EF period due to the influence of the remaining DC voltage in the OF period, flickers are generated.

Particularly, flickering is worsened when pixel data having the same gray-level is displayed in more than one field period. For example, when the same white level is to be displayed during both the first OF and the first EF, the pixel data of the first EF increases due to the DC voltage existing on the horizontal lines of the first OF. Therefore, severe flickers are generated, and the same white level is not displayed in the first OF and the first EF.

### SUMMARY OF THE INVENTION

Accordingly, the present invention is directed to a liquid crystal display device and a method of driving the same that substantially obviate one or more problems due to limitations and disadvantages of the related art.

An object of the present invention is to provide a liquid crystal display device and a method of driving the same based on an interlace type signal.

Another object of the present invention is to provide a liquid crystal display device and a method of driving the same that prevent afterimages and flickers.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a driving circuit for a display device includes a data driver for inverting a polarity of a pixel data at least every two-field period, for converting the pixel data every field period according to a variable gamma voltage, and for supplying the inverted pixel data to a display panel, a value of the variable gamma voltage changing every field period.

In another aspect of the present invention, a method of driving a display device includes inverting a polarity of a pixel data at least every two-field period, converting the pixel data every field period according to a variable gamma voltage, a value of the gamma voltage changing every field period, and supplying the inverted pixel data to a display panel.

In yet another aspect of the present invention, a driving circuit of a display device includes a data driver for inverting a polarity of a pixel data every field period and every n-field period, n being a positive integer equal or greater than 2, and for supplying the inverted pixel data to a display panel.

In a further aspect of the present invention, a method of driving a display device includes inverting a polarity of a pixel data every field period, and inverting the polarity of the pixel data every n-field period, n being a positive integer equal or greater than 2.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1A is a view illustrating polarity arrangement of odd-field pixel data according to the related art;

FIG. 1B is a view illustrating polarity arrangement of even-field pixel data according to the related art;

FIG. 2 is a view illustrating pixel data displayed over time according to the related art;

FIG. 3 is a graph illustrating an amount of a data change over time in one pixel on odd horizontal lines illustrated in FIG. 2;

FIG. 4 is a view illustrating pixel data displayed over time according to the related art;

FIG. 5 is a graph illustrating an amount of a data change over time in one pixel on the odd horizontal lines illustrated in FIG. 4;

FIG. 6 is a graph illustrating a flicker generation in a liquid crystal display device of FIG. 4 according to the related art;

FIG. 7 is a block diagram illustrating a liquid crystal display device according to an embodiment of the present invention;

FIG. 8 is a detailed view illustrating the polar signal generator and the gamma voltage generator shown in FIG. 7;

FIG. 9 is a waveform diagram illustrating a two-field polarity inverting control signal generated by the polar signal generator shown in FIG. 7;

FIG. 10 is a graph illustrating pixel data of the liquid crystal display device shown in FIG. 7;

FIG. 11 is a block diagram illustrating a liquid crystal display device according to another embodiment of the present invention;

FIG. 12 is a waveform diagram illustrating waveforms generated by the polar signal generator and the polarity inverter shown in FIG. 11; and

FIG. 13 is a waveform diagram illustrating pixel data of each field displayed over time in a liquid crystal display device according to an embodiment of the present invention.

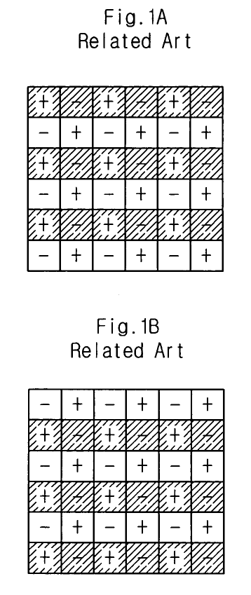

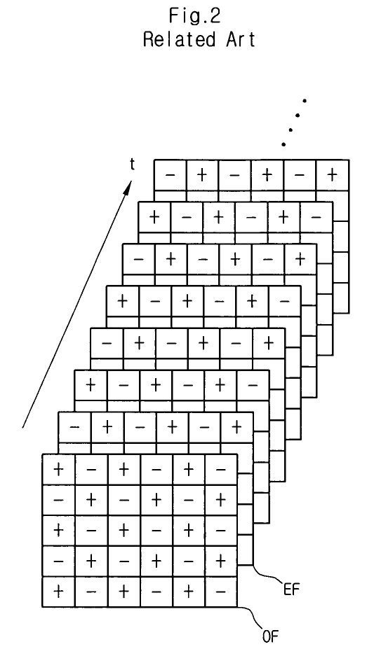

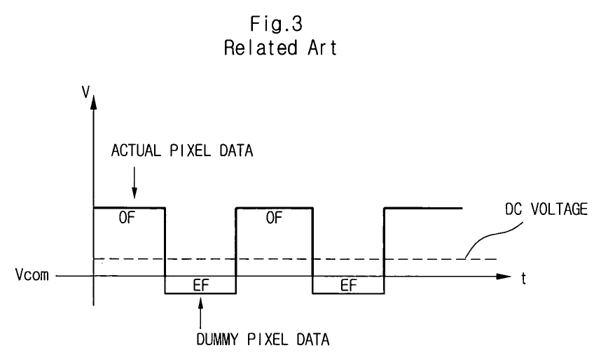

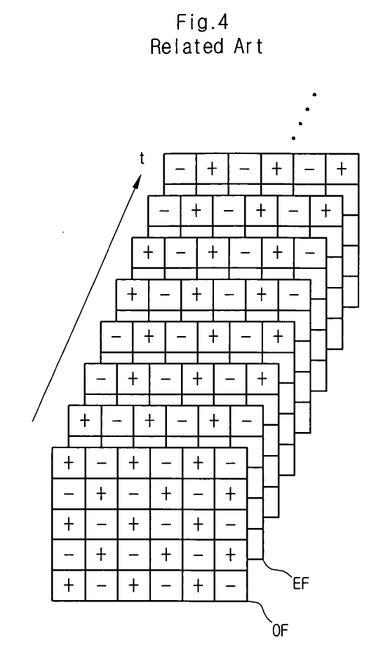

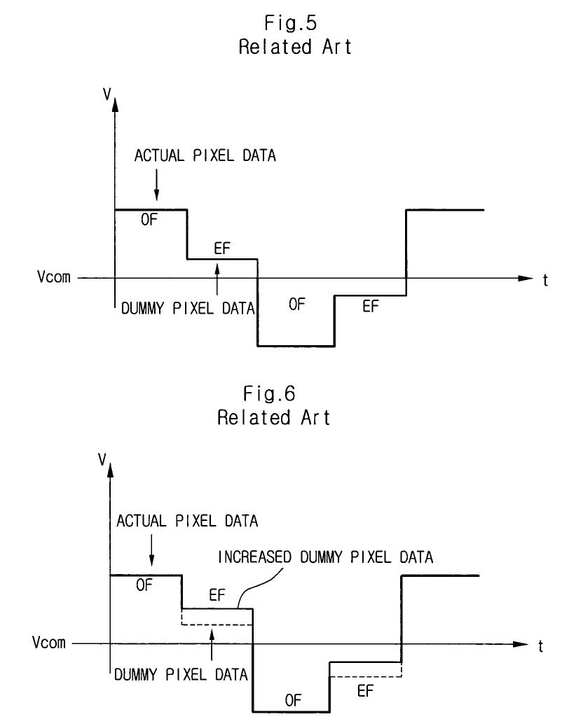

### DETAILED DESCRIPTION OF THE PREFERRED EMBODIMENTS

Reference will now be made in detail to preferred embodiments of the present invention, examples of which are illustrated in the accompanying drawings.

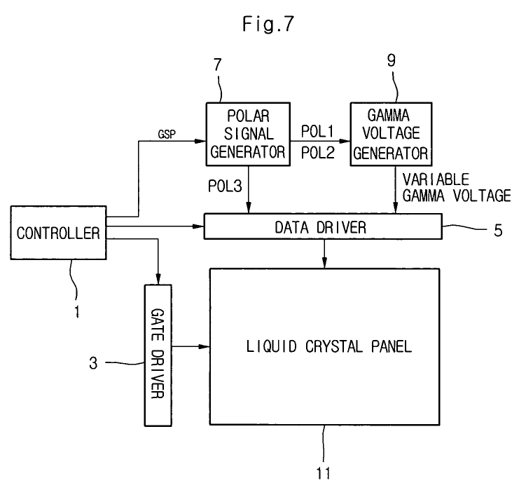

FIG. 7 is a block diagram illustrating a liquid crystal display device according to an embodiment of the present invention. In FIG. 7, a liquid crystal display device includes a controller 1, a gate driver 3, a data driver 5, a polar signal generator 7, a gamma voltage generator 9, and a liquid crystal panel 11.

The controller 1 receives interlace image signals including odd-fields and even-fields from an external graphic card (not shown). In particular, for odd-fields, the controller 1 generates dummy pixel data on even horizontal lines using actual pixel data on adjacent odd horizontal lines of the odd-fields to form one frame, and for even-fields, the controller 1 generates dummy pixel data on odd horizontal lines using actual pixel data on adjacent even horizontal lines of the even-fields to form one frame.

In particular, the odd-fields of an interlace image signal include only actual pixel data on the odd horizontal lines and no actual pixel data on the even horizontal lines. Also, the even-fields of an interlace image signal include only actual pixel data on the even horizontal lines and no actual pixel data on the odd horizontal lines. As such, the interlace image signal as-is cannot be used to drive a liquid crystal display device in which an image is sequentially displayed.

Therefore, based on the received odd-fields of an interlace image signal, the controller 1 generates dummy pixel data on the even horizontal lines. The controller 1 then provides the dummy pixel data to all of the even horizontal lines and the received pixel data of the odd horizontal lines of the odd-fields to allow the pixel data to be sequentially displayed on the liquid crystal display device. Likewise, based on the received even-fields of an interlace image signal, the controller 1 generates dummy pixel data on the odd horizontal lines. The controller 1 then provides the dummy pixel data on the odd horizontal lines and the received pixel data of the even horizontal lines of the even-fields to allow the pixel data to be sequentially displayed on the liquid crystal display device.

In addition, the controller 1 generates the first control signals and the second control signals for driving the gate driver 3 and the data driver 5, respectively. The first control signals may include gate scanning pulse signal GSP, gate shift clock signal GSC, and gate output enable signal GOE are supplied to the gate driver 3. The second control signals may include source scanning pulse signal SSP, source shift clock signal SSC, and source output enable signal SOE.

The gate driver 3 sequentially supplies scan signals to the liquid crystal panel 11 in accordance with the first control signals. The polarity of the pixel data is inverted and displayed every two-field period (odd-field and even-field). In particular, the polar signal generator 7 receives the gate scanning pulse signal GSP and generates a two-field polarity inverting control signal POL3, which is supplied to the data driver 5.

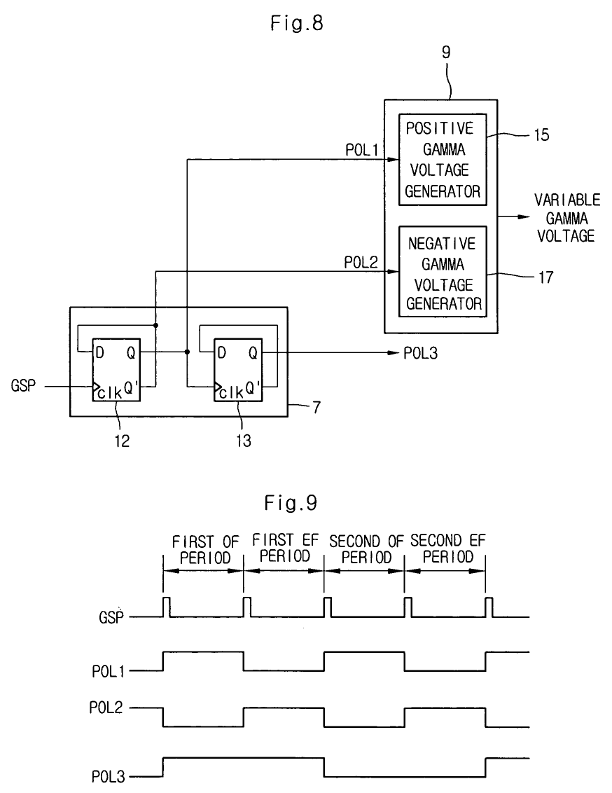

FIG. 8 is a detailed view illustrating the polar signal generator and the gamma voltage generator shown in FIG. 7, and FIG. 9 is a waveform diagram illustrating a two-field polarity inverting control signal generated by the polar signal generator shown in FIG. 7. As shown in FIG. 8, the polar signal generator 7 includes the first D flip-flop 12 and the second D flip-flop 13 connected to the first D flip-flop 12. The first D flip-flop 12 outputs a value of an input terminal D through a non-inverting terminal Q in response to the gate scanning pulse signal GSP. The second D flip-flop 13 outputs a value of an input terminal D through a non-inverting terminal Q in response to a value outputted through the non-inverting terminal Q of the first D flip-flop 12. When the non-inverting terminal Q outputs a high voltage, an inverting terminal Q′ outputs a low voltage. Therefore, the non-inverting terminal Q and the inverting terminal Q′ always output opposite voltages.

As shown in FIG. 9, a high voltage in the gate scanning pulse signal GSP is at a beginning portion of each field period, e.g., each even-field and each odd-field. When the inverting terminal Q′ of the first D flip-flop 12 has maintained a high voltage and a high voltage of the gate scanning pulse signal GSP is inputted to a clock terminal of the first D flip-flop 12, the first D flip-flop 12 outputs a high voltage, which is then inputted to a clock terminal clk of the second D flip-flop 13. At this point, when a high voltage has been applied to the inverting terminal Q′ of the second D flip-flop 13, the second D flip-flop 13 outputs a high voltage in response to the high voltage outputted from the first D flip-flop 12.

Also, the first D flip-flop 12 outputs a low voltage outputted from the inverting terminal Q′ of the first D flip-flop 12 in response to the second high voltage GSP signal. Since the second D flip-flop 13 does not operate due to the above-outputted low voltage, the non-inverting terminal Q of the second D flip-flop 13 outputs the previous high voltage.

The first D flip-flop 12 outputs a high voltage, which is an output of the non-inverting terminal Q, in response to the third high voltage GSP signal, and also the second D flip-flop 13 outputs a low voltage, which is an output of the non-inverting terminal Q, in response to the above-outputted high voltage.

The first D flip-flop 12 outputs a low voltage, which is an output of the non-inverting terminal Q, in response to the fourth high voltage GSP signal, and also the second D flip-flop 13 does not operate due to the above-outputted low voltage and constantly outputs the previous low voltage.

Therefore, the polar signal generator 7 generates a two-field polarity inverting control signal POL3 for inverting polarity by two-field period, which is then supplied to the data driver 5. In addition, the non-inverting terminal Q and the inverting terminal Q′ of the first D flip-flop 12 generate a one-field polarity inverting control signal POL1 or POL2 for inverting polarity by one-field period to supply the signal to the gamma voltage generator 9. The one-field polarity inverting control signals POL1 and POL2 may have a value between 0V and several volts. For example, the polarity inverting control signal is considered as having a low voltage when being at about 0V, and as having a high voltage when being at several volts.

The gamma voltage generator 9 has a positive gamma voltage generator 15 and a negative gamma voltage generator 17. The positive gamma voltage generator 15 is used when positive polarity pixel data is supplied to the liquid crystal panel 11, and the negative gamma voltage generator 17 is used when negative polarity pixel data is supplied to the liquid crystal panel 11. The polarity of the pixel data is inverted by two-field period according to two-field polarity inverting control signal POL3 generated from the polar signal generator in the data driver 5. For example, the positive polarity pixel data is supplied to the liquid crystal panel 11 during the first odd-field period and the first even-field period, and also the negative polarity pixel data is supplied to the liquid crystal panel 11 during the second odd-field period and the second even-field period. Therefore, the pixel data is gamma-converted according to a gamma voltage generated from the positive gamma voltage generator during the first odd-field period and the first even-field period. Also, the pixel data is gamma-converted according to a gamma voltage generated from the negative gamma voltage generator 17 during the second odd-field period and the second even-field period.

As a result, the data driver 5 inverts the polarity of the pixel data supplied from the controller 1 every two-field period, e.g., one odd-field and one even-field, according to the two-field polarity inverting control signal POL3 generated from the polar signal generator 7. Also, the data driver 5 gamma-converts the polarity-inverted pixel data by reflecting the gamma voltage generated from the gamma voltage generator 9 according to the polarity thereof and supplies the gamma-converted pixel data to the liquid crystal panel 11.

Although not shown, the liquid crystal panel 11 includes a first substrate, a second substrate and a liquid crystal layer interposed between the first and second substrates. The first substrate includes horizontal lines and vertical lines crossing each other. Switching elements, such as thin film transistors (TFTs), are connected to the horizontal lines, and pixel electrodes are connected to the TFTs. Pixels are defined by the horizontal lines and the vertical lines. One pixel includes one TFT and one pixel electrode.

The second substrate has red, green, and yellow color filters formed on the regions that correspond to the pixels, a black matrix formed between the respective color filters, a common electrode formed on the color filters and the black matrix, for supplying a common voltage. The liquid crystal panel 11 may have one of twisted nematic (TN), vertical alignment (VA), in-plane switching (IPS), and fringe field switching (FFS) modes.

As described above, the first D flip-flop 12 of the polar signal generator 7 generates a one-field polarity inverting control signal POL1/POL2 for inverting polarity every field period. That is, a high voltage is outputted during the first odd-field period, a low voltage is outputted during the first even-field period from the non-inverting terminal Q of the first D flip-flop 12. Additionally, a high voltage is outputted during the second odd-field period, and a low voltage is outputted during the second even-field period. The non-inverting terminal Q of the first D flip-flop 12 can output a voltage opposite to an output of the inverting terminal Q′. For example, when the output of the non-inverting terminal Q is a high voltage, the output of the inverting terminal Q′ is a low voltage.

A one-field polarity inverting control signal POL1/POL2 outputted from the polar signal generator 7 is supplied to the gamma voltage generator 9. The one-field polarity inverting control signal POL1 outputted from the non-inverting terminal Q of the first D flip-flop 12 of the polar signal generator 7 is supplied to the positive gamma voltage generator 15 of the gamma voltage generator 9. Additionally, a one-field polarity inverting control signal POL2 outputted from the inverting terminal Q′ of the first D flip-flop 12 is be supplied to the negative gamma voltage generator 17 of the gamma voltage generator 9.

The positive gamma voltage generator 15 varies a gamma voltage using the one-field polarity inverting control signal POL1 outputted from the non-inverting terminal Q of the first D flip-flop 12. Therefore, the gamma voltage is varied according to a voltage range of the one-field polarity inverting control signal POL1. For example, the gamma voltage is increased by a high voltage when the one-field polarity inverting control signal POL1 is the high voltage. On the other hand, the gamma voltage is decreased by a low voltage when the one-field polarity inverting control signal POL1 is the low voltage. Therefore, since the one-field polarity inverting control signal POL1/POL2 is a voltage, such that a high voltage and a low voltage are inverted by the field period, the gamma voltage is increased by a high voltage and decreased by a low voltage by the field period. For example, the positive gamma voltage generator 15 outputs a gamma voltage increased by a high voltage during the first odd-field period, and then outputs a gamma voltage decreased by a low voltage during the following field, e.g., the first even-field period. The negative gamma voltage generator 17 outputs a gamma voltage decreased by a low voltage during the second odd-field period, and then outputs a gamma voltage increased by a high voltage during the second even-field period.

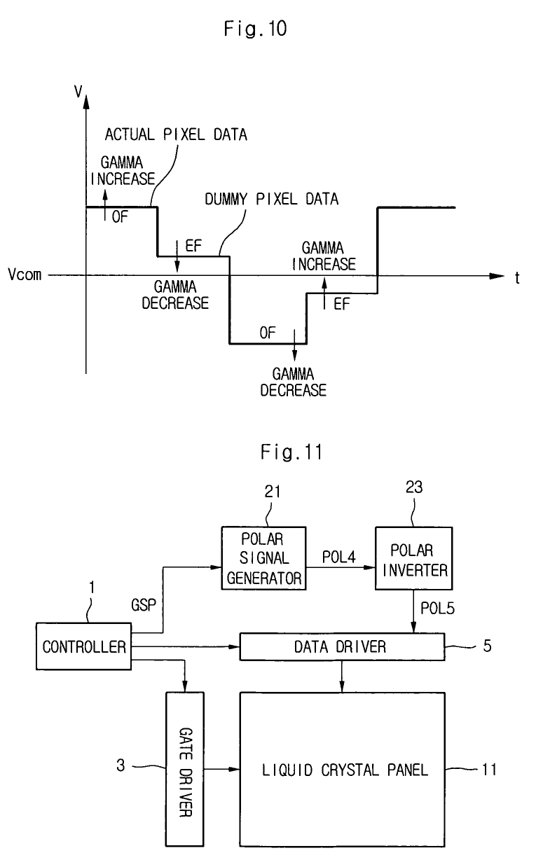

FIG. 10 is a graph illustrating pixel data of the liquid crystal display device shown in FIG. 7. The data driver 5 (shown in FIG. 7) gamma-converts the pixel data according to the variable gamma voltage. As shown in FIG. 10, the pixel data is increased by a high voltage of the variable gamma voltage during the first odd-field period. Next, the pixel data is decreased by a low voltage of the variable gamma voltage during the first even-field period. In particular, the pixel data in the first odd-field period and the first even-field period have the same positive polarity. Such gamma-converted pixel data is supplied to the liquid crystal panel 11 (shown in FIG. 7) by the field period. Therefore, the pixel data is increased more than actual pixel data during the first odd-field period and decreased more than actual pixel data during the first even-field period, thereby preventing an increase of the pixel data in the first even-field due to DC voltage during the first odd-field period. Therefore, flickers and afterimages are prevented.

The pixel data is decreased by a low voltage during the second odd-field period and is increased by a high voltage during the second even-field period. In particular, the pixel data in the second odd-field period and the second even-field period have the same negative polarity. Such gamma-converted pixel data is supplied to the liquid crystal panel 11 (shown in FIG. 7) by the field period. Therefore, the pixel data is decreased more than actual pixel data during the second odd-field period and increased more than actual pixel data during the second even-field period, thereby preventing an increase of the pixel data of the second even-field due to DC voltage during the second odd-field period. Therefore, flickers and afterimages are prevented.

Accordingly, a driving circuit according to an embodiment of the present invention prevents flickers and afterimages by reflecting the variable gamma voltage in the pixel data each field period. For example, the gamma voltage sequentially has an increased voltage, a decreased voltage, another decreased voltage and another increased voltage in every four-field period. As a result, pixel data of positive polarity is displayed during a first two-field period, e.g., the first odd-field period and the first even-field period, and pixel data of negative polarity is displayed during the following two-field period, e.g., the second odd-field period and the second even-field period. In addition, although not shown, the driving circuit reflecting the variable gamma voltage in pixel data each field period may be employed in other progressive types display devices, such as plasma display panel (PDP) devices and electroluminescent display (ELD) devices.

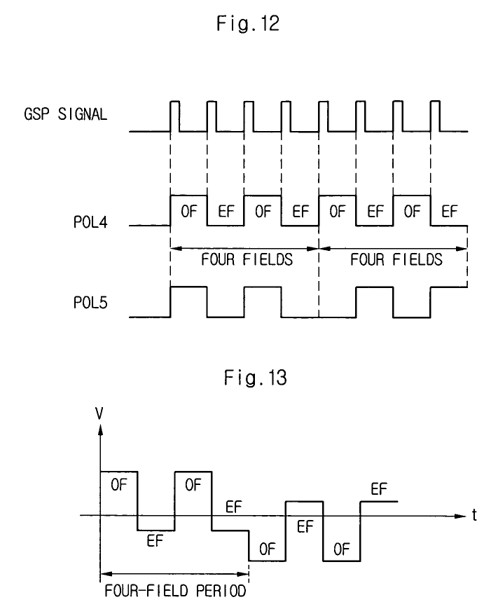

FIG. 11 is a block diagram illustrating a liquid crystal display device according to another embodiment of the present invention, and FIG. 12 is a waveform diagram illustrating waveforms generated by the polar signal generator and the polarity inverter shown in FIG. 11. In FIG. 11, a liquid crystal display device includes a controller 1, a gate driver 3, a data driver 5, a polar signal generator 21, a polar inverter 23, and a liquid crystal panel 11. The liquid crystal display device further includes a gamma voltage generator (not shown) converting an image signal into pixel data. The polar signal generator 21 generates a one-field polarity inverting control signal POL4, which is applied to the polar inverter 23. The polar inverter 23 generates a n-field polarity inverting control signal POL5 by inverting a polarity of the one-field polarity inverting control signal POL4 generated from the polar signal generator 21 every an n-field period, n being a positive odd or even integer.

As shown in FIG. 12, the one-field polarity inverting control signal POL4 has alternately a positive signal and a negative signal in synchronization with a GSP signal supplied from the controller 1 (shown in FIG. 11). For example, the polar signal generator 21 outputs a positive polar signal during a first field OF period, a negative polar signal during a second field EF period, a positive polar signal during a third field OF period, a negative polar signal during a fourth field EF period, a positive polar signal during a fifth field OF period, a negative polar signal during a sixth field EF period, a positive polar signal during a seventh field OF period, and a negative polar signal during a eighth field EF period sequentially.

For example, when n is 4, a polarity is inverted during the fifth field OF period after the fourth field EF period when the polar inverter 23. Accordingly, the polarity is inverted to the negative polar signal during the fifth field OF period, the positive polar signal during the sixth field EF period, the negative polar signal during the seventh field OF period, and the positive polar signal during the eighth field EF period.

The data driver 5 supplies the pixel data, where a polarity is inverted by the n-field period according to the n-field polarity inverting control signal POL5 supplied from the polar inverter 23 to the liquid crystal panel 11. Thus, the polarity is inverted every one-field period and every n-field period.

FIG. 13 is a waveform diagram illustrating pixel data of each field displayed over time in a liquid crystal display device according to an embodiment of the present invention. As shown in FIG. 13, when n is 4, in a four-field period, actual pixel data of a positive polarity is displayed during the first field OF period, and a dummy pixel data of a negative polarity is displayed during the second field EF period. Additionally, actual pixel data of a positive polarity is displayed during the third field OF period, and a dummy pixel data of a negative polarity is displayed during the fourth field EF period.

In a following four-field period, actual pixel data of a negative polarity is displayed during the fifth field OF period, and a dummy pixel data of a positive polarity is displayed during the sixth field EF period. Additionally, actual pixel data of a negative polarity is displayed during the seventh field OF period, and a dummy pixel data of a positive polarity is displayed during the eighth field EF period.

Accordingly, the actual pixel data and the dummy pixel data cancel each other in the first four-field period having the first-to-fourth field and the second four-field period having the fifth-to-eighth field. Therefore, the actual voltage becomes about zero. For example, actual pixel data of a positive polarity during the first field period and actual pixel data of a negative polarity during the fifth field period cancel each other. Additionally, a dummy pixel data of a negative polarity during the second field period and a dummy pixel data of a positive polarity during the sixth field period cancel each other. Moreover, actual pixel data of a positive polarity during the third field period and actual pixel data of a negative polarity during the seventh field period cancel each other. Furthermore, a dummy pixel data of a negative polarity during the fourth field period and a dummy pixel data of a positive polarity during the eighth field period cancel each other. Accordingly, since pixel data of the first four-field period and pixel data of the second four-field period cancel each other and collectively have a zero value. As a result, no DC voltage is remained on the panel. Therefore, flickers and afterimages are prevented, to thereby provide an improved image quality.

Although the four-field period is described above, the n-field polarity inversion period is not limited to the four-field period and may be a five-field period, an eight-field period, a sixteen-field period, or 2ˆm field period, m being a positive integer greater or equal to two. Therefore, pixel data of each field may cancel each other and collectively have a zero value.

Accordingly, a driving circuit according to another embodiment of the present invention prevents flickers and afterimages by inverting polarity of pixel data every one-field period and every n-field period. In addition, although not shown, the driving circuit inverting polarity of pixel data every one-field period and every n-field period may be employed in other progressive types display devices, such as plasma display panel (PDP) devices and electroluminescent display (ELD) devices.

It will be apparent to those skilled in the art that various modifications and variations can be made in the liquid crystal display device and the method of driving the same of the present invention without departing from the spirit or scope of the invention. Thus, it is intended that the present invention covers the modifications and variations of this invention provided they come within the scope of the appended claims and their equivalents.

What is claimed is:

1. A driving circuit for a display device, comprising:
a data driver for inverting a polarity of a pixel data at least every two-field period, for converting the pixel data every field period according to a variable gamma voltage, and for supplying the inverted pixel data to a display panel, a value of the variable gamma voltage changing every field period.

2. The driving circuit according to claim 1, further comprising:
a polar signal generator for generating a first polar signal for alternately inverting the polarity between a high voltage and a low voltage every field period, and for generating a second polar signal for inverting the first polar signal every field period; and
a gamma voltage generator for varying the gamma voltage based on one of the first and second polar signals.

3. The driving circuit according to claim 2, wherein the polar signal generator generates a third polar signal for alternately inverting the polarity using the first polar signal every two-field period, and a polarity of the gamma voltage is based on the third polar signal.

4. The driving circuit according to claim 3, wherein when the third polar signal has a positive polarity, the gamma voltage generator increases the gamma voltage by the high voltage of the first polar signal during a first field period and decreases the gamma voltage by the low voltage of the first polar signal during a second field period.

5. The driving circuit according to claim 3, wherein when the third polar signal has a negative polarity, the gamma voltage generator decreases the gamma voltage by a low voltage of the second polar signal during a third field period and increases the gamma voltage by a high voltage of the second polar signal during a fourth field period.

6. The driving circuit according to claim 1, wherein the data driver receives an interlace type video data signal.

7. The driving circuit according to claim 1, wherein the pixel data includes received pixel data and dummy pixel data, the dummy pixel data generated based on the received pixel data.

8. The driving circuit according to claim 1, wherein the data driver changes the pixel data of a first field period according to an increased gamma voltage, and changes the pixel data of a second field period according to a decreased gamma voltage.

9. The driving circuit according to claim 8, wherein the data driver changes the pixel data of a third field period according to the decreased gamma voltage, and changes the pixel data of a fourth field period according to the increased gamma voltage.

10. A method of driving a display device, comprising:
inverting a polarity of a pixel data at least every two-field period;
converting the pixel data every field period according to a variable gamma voltage, a value of the gamma voltage changing every field period; and
supplying the inverted pixel data to a display panel.

11. The method according to claim 10, further comprising:
generating a first polar signal for alternately inverting the polarity between a high voltage and a low voltage every field period;
generating a second polar signal for inverting the first polar signal every field period; and
varying the gamma voltage based on one of the first and second polar signals.

12. The method according to claim 11, further comprising:
generating a third polar signal for alternately inverting the polarity using the first polar signal every two-field period; and
selecting a polarity of the gamma voltage based on the third polar signal.

13. The method according to claim 12, further comprising:
when the third polar signal has a positive polarity, increasing the gamma voltage by the high voltage of the first polar signal during a first field period and decreasing the gamma voltage by the low voltage of the first polar signal during a second field period.

14. The method according to claim 12, further comprising:
when the third polar signal has a negative polarity, decreasing the gamma voltage by a low voltage of the second polar signal during a third field period and increasing the gamma voltage by a high voltage of the second polar signal during a fourth field period.

15. The method according to claim 10, wherein the converting the pixel data includes:
changing the pixel data of a first field period according to an increased gamma voltage, and changing the pixel data of a second field period according to a decreased gamma voltage.

16. The method according to claim 15, wherein the converting the pixel data includes:
changing the pixel data of a third field period according to the decreased gamma voltage, and changing the pixel data of a fourth field period according to the increased gamma voltage.

17. A driving circuit of a display device, comprising:
a data driver for inverting a polarity of a pixel data every field period and every n-field period, n being a positive integer equal or greater than 2, and for supplying the inverted pixel data to display panel.

18. The driving circuit according to claim 17, wherein n is a positive even integer.

19. The driving circuit according to claim 17, further comprising:
a polar signal generator for generating a polar signal for alternately inverting the polarity between a high voltage and a low voltage every field period; and
a polarity inverter inverting a polarity of the polar signal every n-field period.

20. The driving circuit according to claim 17, wherein the data driver receives an interlace type video data signal.

21. The driving circuit according to claim 17, wherein the pixel data includes received pixel data and dummy pixel data, the dummy pixel data generated based on the received pixel data.

22. A method of driving a display device, comprising:
inverting a polarity of a pixel data every field period; and
inverting the polarity of the pixel data every n-field period, n being a positive integer equal or greater than 2.

23. The method according to claim 22, wherein n is a positive even integer.

24. The method according to claim 22, further comprising:
generating a polar signal for alternately inverting the polarity between a high voltage and a low voltage every field period; and
inverting a polarity of the polar signal every n-field period.

25. The method according to claim 22, further comprising:
receiving an interlace type video data signal.

26. The method according to claim 25, further comprising:
generating dummy pixel based on the received interlace type video data signal.
